(19) United States
(12) Patent Application Publication
(10) Pub. No.: US 2004/0047331 A1
(43) Pub. Date: Mar. 11, 2004

(54) Data transfer controlling method in mobile communication system

(75) Inventor: Sung-Kyung Jang, Anyang (KR)

Correspondence Address: FLESHNER & KIM, LLP, P.O. BOX 221200, CHANTILLY, VA, 20153, US

(73) Assignee: LG Electronics Inc.

(21) Appl. No.: 10/650,792

(22) Filed: Aug. 29, 2003

(30) Foreign Application Priority Data
Sep. 7, 2002 (KR) 54047/2002

(51) Int. Cl. H04J 3/16

(52) U.S. Cl. 370/346; 370/449

(57) ABSTRACT

A data transfer controlling method in a mobile communication system, in which a window size SUFI (super-field) is controlled and thus a receiving buffer for a transfer of next data is controlled, thereby preventing a damage such as a data loss. For a reception of a protocol data unit (PDU) of a radio link control (RLC) layer, the window size SUFI and the receiving buffer are properly controlled, thereby preventing a data loss according to a buffer overflow, a time delay, and a waste of a radio resource. Also, the present invention can provide affirmative effects on the 3GPP communication standard by disclosing a positive utilization method of the window size SUFI only of which form has been defined.

### BACKGROUND OF THE INVENTION

1. Field of the Invention

The present invention relates to a mobile communication system, and more particularly, to a data transfer controlling method by a radio link control (RLC) layer.

2. Description of the Related Art

Generally, an internet service based on a cable network has been developed as a representative data communication system through various applications, and a cellular mobile telecommunication network technique takes its place as a universal audio communication means. According to this, users desire to be provided with a data transfer service such as a moving image and etc. more freely by using a wireless terminal which is portable and does not require a cable, and expect a quality in a wireless network to be the same as that in the existing cable network or better than that. To this end, IMT-2000, a next generation mobile communication service was developed to provide a fast wireless packet data service. However, the existing internet applications are services based on TCP/IP, protocols for a cable network, and applying the protocols to a wireless network as they are is unreasonable. To solve the problem, various researches for efficiently providing an internet service through a radio access are being performed, and the researches can be largely divided into two access methods. The first method is correcting, complementing, and developing the existing internet protocols in a direction suitable for a wireless environment. And, the second method is to design a data link control protocol below a link layer, a radio access control protocol, a physical layer protocol to be suitable for an internet service. Said both methods are actively being researched now.

In December 1998, European ETSI, Japanese ARIBFTTC, American TI, Korean TTA, and etc. constructed a project, the third generation partnership project (3GPP), and have written detail specifications of a universal mobile terrestrial system (UMTS).

In the 3GPP, for developing the UMTS faster and more efficiently, a standardization work is being performed by being divided into 5 technical specification groups (TSG). Each TSG develops a standard in a relevant region, acknowledges, and manages. Among these, a TSG-RAN (radio access network) group develops functions of a universal mobile telecommunications network terrestrial radio access network (UTRAN) which is a new RAN for applying a wideband code division multiple access (WCDMA) technique in the UMTS, demand items, and an interface standard.

FIG. 1 is a structure of a radio access interface protocol used between a terminal and a UTRAN based on a 3GPP radio access network standard.

Referring to FIG. 1, the radio access interface protocol is composed of a physical layer (PHY), a data link layer, and a network layer in a horizontal direction, and is composed of a control plane for transmitting a control signal and a user plane for transmitting data information in a vertical direction.

The protocol layer can be divided into a first layer L1, a second layer L2, and a third layer L3 on the basis of 3 lower layers of an open system interconnection (OSI) standard model widely known in a communication system.

The second layer L2 is a data link layer, and makes plural terminals share a radio resource of a WCDMA network. The second layer is divided into a media access control (MAC) layer, a radio link control (RLC) layer, a packet data convergence protocol (PDCP) layer, and a broadcast/multicast control (BMC) layer.

In the meantime, the TSG-RAN group is composed of one plenary group and four working groups. Among these, a second working group prescribes functions of the second layer L2 and the third layer L3.

According to a 3GPP RLC protocol specification prescribed by the second working group, the RLC layer is one of the data link layer, the second layer L2. The RLC layer constitutes a protocol data unit (PDU) suitable for transfer by segmenting a protocol data unit (PDU) received from an upper layer, reassembling, and concatenating, and performs an automatic repeat request (ARQ) function for re-transmitting a PDU lost during transfer. The RLC layer is operated in three modes, that is, a transparent mode (TM), an unacknowledged mode (UM), and an acknowledged mode (AM), and a selected mode is dependent on a processing method of a PDU received from an upper layer. Also, the RLC layer is provided with an RLC buffer for storing SUDs or PDUs received from an upper layer.

As aforementioned, the RLC layer is operated in TM, UM, and AM. Among these, only the AM applied to the present invention will be explained.

The most distinct characteristic of the AM is to apply a retransfer of a PDU when the PDU has not been successfully transmitted or received. Especially, if a transmitting end RLC layer transmits PDUs, a receiving end RLC informs a receiving state for each PDU to the transmitting end by status information. If the transmitting end RLC receives status information that a PDU is not received, the transmitting end RLC re-transmits a PDU to the receiving end RLC.

Also, the RLC layer controls a flow of each PDU by using several state variables and windows for a data link control. The window denotes a size of a PDU which can be transmitted at one time without an acknowledge signal, which means a size of a buffer provided at transmitting/receiving ends.

A PDU, a basis unit for transmitting and receiving in the RLC layer, is constructed by adding a header including a sequence number (SN) to a service data unit (SDU) transmitted from an upper layer. One PDU can be composed of several SDUs or a part of one SDU.

The PDUs are first stored in the RLC buffer and adjusted to correspond to a transmitting window, thereby being transmitted to the receiving end. The receiving end checks whether a SN of a received PDU is within a receiving window or out of the receiving window.

As the result, if the SN of a received PDU is out of the receiving window, it is ignored. Also, if it is within the receiving window, it is checked whether an error of each received PDU exists or not. According to this, status information for informing an acknowledge or a negative acknowledge of each PDU is transmitted to the transmitting end RLC. At this time, the receiving window and the transmitting window have the same size. The transmitting end RLC re-transmits a PDU of a negative acknowledge to the receiving end, in which a status PDU is used to transmit the status information to the transmitting end RLC.

FIG. 2 shows a structure of a general status PDU.

As shown in FIG. 2, the status PDU has a length of 8 bits, and includes a plurality of different super-fields (SUFI₁˜SUFIₖ) 3 and 4. Also, the status PDU includes a D/C field 1 of one bit denoting a data PDU/control PDU; and a PDU type field 2 of 3 bits denoting a kind of a PDU such as ACK and NAK.

The SUFI (super-field) is constructed by a structure of various number of bits, and if necessary, a plurality of SUFIs can be simultaneously included. For example, the receiving RLC can simultaneously transmit an ACK SUFI and a window size SUFI. The status PDU includes a plurality of SUFIs. Herein, a no more data SUFI is inserted to a last SUFI (SUFIₖ), and a padding field 5 filled with padding bits in the rest spaces is further included to the status PDU in order to correspond a size of the status PDU.

Several state variables are used for transmitting and receiving a PDU. A state variable used for a control of the transmitting RLC includes a send state variable VT(S), an acknowledge state variable VT (A), and a Tx_window_size for denoting a transmitting window size. Herein, the VT(S) corresponds to a sequence number (SN) of a first PDU except re-transfer PDUs among RLC PDUs to be transmitted next, and the VT(A) corresponds to a sequence number of a first PDU among PDUs to be acknowledged next. Also, there is a VT(MS), a maximum send state variable corresponding to a sequence number of a first PDU among RLC PDUs not to be transmitted next (that is, the receiving end is allowed to receive only up to VT(MS)−1).

The Tx_window_size corresponds to a maximum value of the number of PDUs which can be transmitted at one time without an acknowledge. The VT(A) forms a lower edge and the VT(MS) forms an upper edge, thereby having a relation of VT(MS)=VT(A)+Tx_window_size.

The VT(S) has an initial value of ‘0’, and the value is increased as one whenever one PDU is transmitted except re-transfer. A PDU only in the Tx_window_size is allowable to be transmitted, so that a minimum value of the SN is the VT(A) and the maximum value thereof is the VT(MS)−1.

In the meantime, the receiving end checks whether each PDU is received or not, and transmits ACK/NAK information to the transmitting end through a status PDU, thereby demanding re-transfer.

Herein, a SN of a first PDU among PDUs to be transmitted or re-transmitted to the receiving end is called as a receive state variable, VR(R).

Also, a SN of a first PDU among PDUs not to be transmitted or re-transmitted to the receiving end is called as a maximum acceptable receive state variable, VR(MR). The VR(R) and the VR(MR) respectively form a lower edge and an upper edge of the receiving window, thereby having a relation of VR(MR)=VR(R)+Rx_window_size.

Herein, the Rx_window_size is a receiving window size, and generally has the same value as the transmitting window size. Also, a receiving end which will receive transmitted PDUs updates the VR(R) by a SN of a first PDU where an error is generated, and updates the VR(MR) by using the relation of VR(MR)=VR(R)+Rx_window_size.

The transmitting window size is equal to the receiving window size, so that explanations will be given on the basis of the receiving window size.

FIG. 3 shows an RLC RX window size, in which each block denotes a PDU and a relation of VR(MR)=VR(R)+Rx_window_size is explained.

As shown in FIG. 3, the Rx_window_size has a length from the VR(R) having a SN of a first PDU to the VR(MR)−1 having a SN of a final PDU, and the length is consistent with a buffer size of each transmitting/receiving end. By using this buffer, received PDUs are aligned by a sequence number and the aligned PDUs are transmitted to an upper layer.

A transmitting RLC which has received a status PDU in which ACK/NAK information for each PDU is contained updates a value of the VT(A) into a value of the VR(R), and updates a value of the VT(MS) by using the relation of VT(MS)=VT(A)+Tx_window_size. Corresponding to this, the transmitting end re-transmits PDUs required by the receiving end.

The SUFI inserted to the status PDU transmitted to the transmitting RLC by the receiving end after a reception of PDUs is completed in order to inform the Rx/Tx_window sizes and ACK information will be explained in more detail.

FIG. 4 shows a general SUFI structure and a window size SUFI and an ACK SUFI structure based on the general SUFI structure.

As shown in FIG. 4, a SUFI 20 is composed of three sub-fields, a type field 21 denoting a kind of a SUFI, a length field 22 denoting a length of a corresponding SUFI, and a value field 23 for a SUFI having a value. According to a kind, the SUFI can use only a part among the type field 21, the length field 22, and the value field 23. For example, the window size SUFI 30 and an ACK SUFI 40 use only the type field 21 and the length field 22.

The window size SUFI 30 includes a type field 31 of 4 bits denoting a kind of a SUFI (WINDOW). Also, the window size SUFI 30 includes a length field 32 where a window size number (WSN) of 12 bits which means the aforementioned Tx/Rx_window size is located. Therefore, an allowable size of a window is theoretically a region of [0, 2¹²−1].

The ACK SUFI 40 is composed of a type field 41 of 4 bits denoting a kind of a SUFI (ACK), and a length field 42 where an acknowledged last sequence number (LSN) is located. Through this, the transmitting RLC can check an amount of PDU data acknowledged by a current receiving end.

Meanwhile, at the time of transmitting and receiving PDUs, if PDUs remain on a transmitting/receiving buffer too long or an error is generated on PDUs, corresponding PDUs are all discarded thus to enhance an efficiency of a buffer and a limited radio resource.

However, the transmitting/receiving window sizes are equal to each other in the transmitting/receiving RLC, and an initial size of the transmitting/receiving lo window is set as a very great value, that is, an upper limit. If a specific PDU which has been expected to be received is not received yet by a SN, the receiving RLC does not transmit received PDUs to an upper layer even if PDUs after a corresponding PDU are all received, but waits a PDU which has not been received. Then, if a corresponding PDU is received and thereby a receiving buffer is filled, the receiving RLC transmits an ACK signal to the transmitting RLC and arranges data stored in the receiving buffer by a sequence. At this time, the transmitting RLC transmits next PDUs corresponding to the transmitting window size to the receiving RLC by the ACK signal. According to this, if all data in the receiving buffer (Rx window) are not arranged by a sequence before next data are received from the transmitting RLC, a time delay is generated in transmitting data to an upper protocol. This time delay generates a loss of transmitted data, thereby wasting a radio resource and interrupting a data transfer service.

### SUMMARY OF THE INVENTION

Therefore, an object of the present invention is to provide a data transfer controlling method in a mobile communication system capable of preventing a loss of transfer data and a processing delay of a receiving end in a radio link control (RLC).

Another object of the present invention is to provide a data transfer controlling method in a mobile communication system capable of efficiently controlling an overflow of a buffer.

Still another object of the present invention is to provide a data transfer controlling method in a mobile communication system capable of adaptively controlling a window size according to a processing speed of a receiving buffer.

To achieve these and other advantages and in accordance with the purpose of the present invention, as embodied and broadly described herein, there is provided a data transfer controlling method in a radio system where data is transmitted or received by an acknowledge mode, the method comprising the steps of: transmitting window size control information to a transmitter from a receiver by a state of a receiving buffer; and varying a transmitting window size by the transmitter according to the transmitted window size control information. Herein, the transmitter is a network and the receiver is a terminal.

Preferably, the window size control information is transmitted through status information, and the status information is composed of a super-field (SUFI) and an acknowledge (ACK) SUFI.

Preferably, the window size control information includes window size downward setting information if the receiving buffer is in an overflow state, and the downward set window size is 1.

Preferably, the window size control information includes window size upward setting information if the receiving buffer is not an overflow, and the upward setting is up to an upper limit.

According to the data transfer controlling method of the present invention, in a radio system which controls a flow of a radio link and includes an entity operated in an acknowledge mode, window size update information is transmitted from a receiving entity to a transmitting entity based on a processing speed of a receiving buffer.

Preferably, the entity is a radio link control (RLC).

Preferably, the window size update information is transmitted through status information.

Preferably, the window size update information is a window size super-field (SUFI).

Preferably, the status information is an acknowledge (ACK) SUFI.

Preferably, the receiving entity determines a change of a window size according to a state of a receiving buffer. In this case, the receiving entity controls a window size to be downward set at the time when data more than a certain level remains on the receiving buffer, and controls a window size to be upward set at the time when data more than a certain level does not remain on the receiving buffer.

Preferably, the upward setting is up to an upper limit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a structure of a radio interface protocol between a terminal based on a 3GPP radio access network (RAN) standard and an UTRAN;

FIG. 2 shows a structure of a status protocol data unit (PDU);

FIG. 3 shows a structure of a receiving buffer according to a window size;

FIG. 4 shows a basic structure of a super-field (SUFI) and structures of a window size SUFI and an acknowledge (ACK) SUFI;

FIG. 5 shows a flow of a preferred embodiment of the present invention; and

FIG. 6 is a flow chart showing a buffering control method of a radio link control layer according to the present invention.

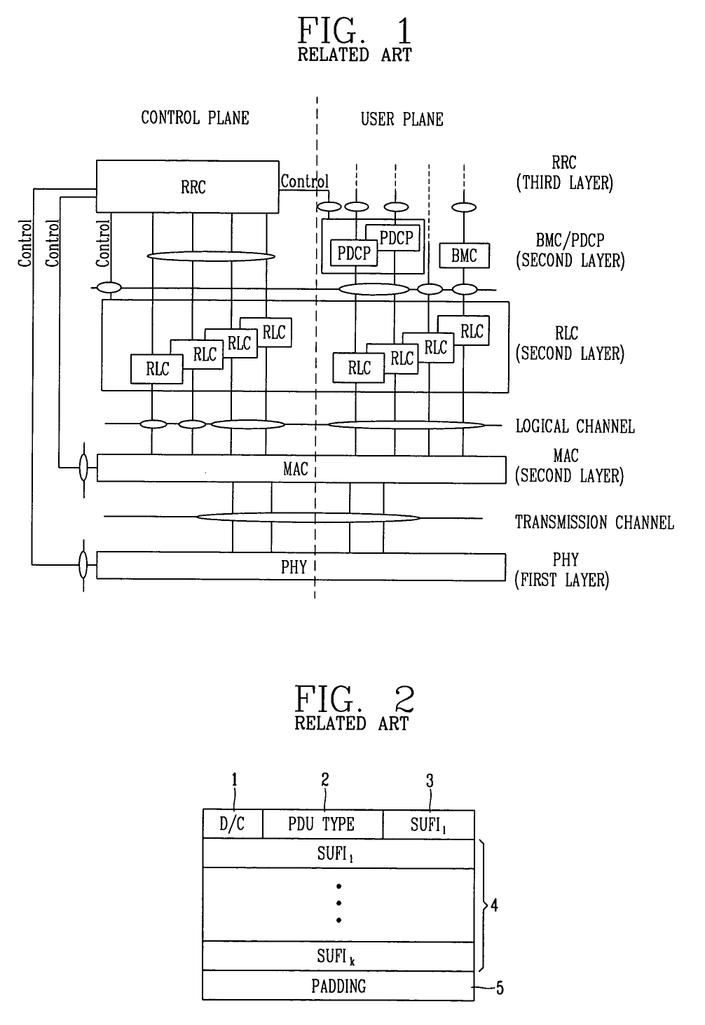

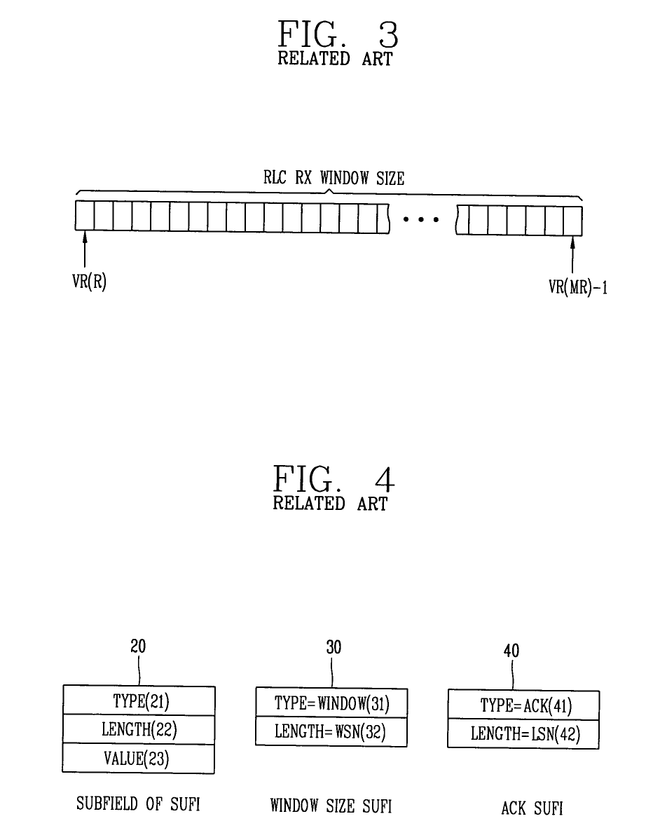

### DETAILED DESCRIPTION OF THE PREFERRED EMBODIMENTS

Reference will now be made in detail to the preferred embodiments of the present invention, examples of which are illustrated in the accompanying drawings.

Generally, in a current IMT-2000 RLC specification (25.322 V3.14.0), only a definition of a structure and etc. for a window size SUFI (super-field) is described and a method for efficiently using the SUFI in a proper circumstance is not described, thereby having many problems in realization.

Accordingly, the present invention provides a method for controlling a window size based on a newly received data amount and thus transmitting PDU data by properly utilizing the SUFI. Also, the present invention provides a method for repeating the steps of transmitting an ACK signal and properly controlling a window size by considering a buffer margin.

Hereinafter, preferred embodiments of the present invention will be explained with reference to the attached drawings.

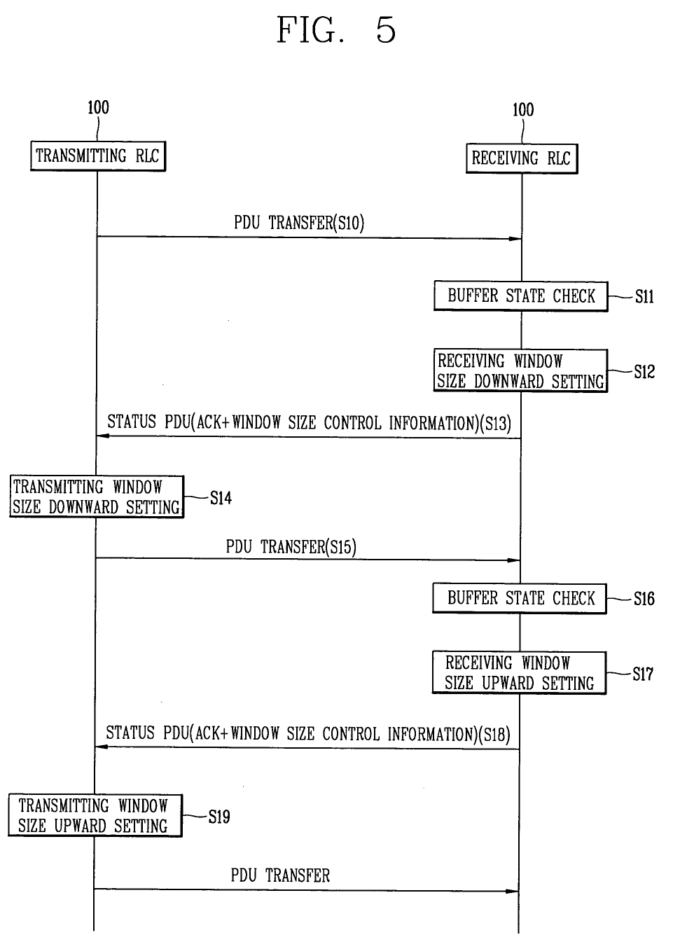

FIG. 5 shows a signal flow between a transmitting RLC and a receiving RLC according to the present invention.

Referring to FIG. 5, a data transfer controlling method in a mobile communication system will be explained as follows.

First, a window size is set as a size of [0,2¹²−1], thereby having a very great value as an initial value. Herein, the window size is supposed to have an upper limit as the initial value. Also, it is supposed that the rest data ([VR(R+1), VR(MR)−1]) have been already received in a state that VR(R) has not been received in the receiving RLC by a data transfer path.

The initially set window size is the same as that of a transmitting/receiving buffer, and is set to transmit PDU data of a corresponding size at one time without a reception of an ACK signal. That is, a transmitting RLC 100 sequentially transmits PDU data corresponding to a transmitting window size, and a receiving RLC layer 200 receives the PDU data through a receiving window (S10). At this time, each PDU data has a SN and temporarily stored in a buffer.

In this case, the transmitting RLC is provided at a receiving terminal side of a network. The receiving RLC 200 sequentially arranges each received PDU by a sequence. The PDU data arranged by a sequence order are transmitted to an upper layer. The process is simultaneously performed while receiving PDU data. Also, the process includes a step of waiting until PDU data having right sequence numbers are received if PDU data having wrong sequence numbers are received. The waiting time can be ignored if a data amount to be arranged by a sequence is less. However, if a re-arrangement data amount is much, waiting time can be long and much data can be transmitted to an upper layer at one time. Accordingly, time to process much data transmitted to the upper layer can be greater than a communication speed process ability of a radio interface, in which data to be received next can be lost.

A state of the preferred embodiment is that the receiving RLC 200 has not received data of the VR(R). According to this, even if the receiving RLC 200 has received all the rest data, a sequence arrangement for that can be performed and the rest data can be transmitted to the upper layer. In this state, if data of the VR(R) is received (S10) and an ACK signal for a current received content is required by the transmitting RLC 100, it means that a reception of all the PDU data has been completed. Thus, the receiving RLC 200 has to transmit an ACK signal for the received PDUs.

Herein, if a status PDU including only an ACK SUFI is transmitted to the transmitting RLC 100, the transmitting RLC 100 will start to transmit new PDU data of an initial size (upper limit). However, since a current receiving buffer does not have a margin, the receiving RLC has to arrange all the received PDU data by a sequence number before new data is received and transmit to an upper layer. A processing of the transmitted data has to be completed in the upper layer. However, said process includes a possibility of a data loss in case that a buffer size is bigger than a data amount processable in the upper layer. Accordingly, in order to solve this problem, an amount of PDU data to be transmitted next will be controlled through a control method based on the present invention.

First, it is checked that PDUs more than a preset amount remain in a buffer or not (S11). If PDUs more than a preset amount remain in the receiving buffer, it is anticipated that time for processing the PDUs will be longer than time which takes for next transmitted data to reach. Accordingly, in order to minimize an amount of data to be newly received while processing currently received PDU data, an ACK SUFI and window size control information are contained in the status PDU which provides ACK information for currently received data information, and then transmitted to the transmitting RLC (13). Preferably, the window size control information is a window size SUFI which has set a window size (WSN) as ‘1’ (S12).

According to the 3GPP communication standard, SUFIs of a desired number can be inserted into the status PDU, and a receiving end can always change a window size during a communication connection. Therefore, in order to greatly reduce a reception of new data, the window size SUFI for transmitting the status PDU having the ACK SUFI and reducing the window size as ‘1’ can be included.

The window size SUFI transmits the ACK signal for the received PDU data to the transmitting RLC, and at the same time transmits an order for the window size to be controlled downward. According to this, the transmitting RLC controls the window size as ‘1’ (S14) and thereby transmits PDU data (S15). At this time, data corresponding to one widow size are transmitted, so that an ACK signal is not required from the receiving end whenever a data transmission is completed but the ACK signal is required when predetermined data are transmitted.

Like this, since a size of next data becomes greatly small, the receiving buffer can accept the next data without loss and the previously received PDU data can be arranged by a sequence thus to be transmitted to an upper layer. Also, in the upper layer, the previously received data are processed and next data having a small size can be processed without a problem.

After transmitting predetermined data through the step S15, the network (the transmitting RLC) requests an ACK signal from the terminal (the receiving RLC). Then, the receiving RLC of the terminal checks its buffer state (S16), and contains a window SUFI for ordering a window size to be upward set in the status PDU by an amount of a buffer margin generated due to a decrease of the window size (S17) thus to transmit to the transmitting RLC of the. At this time, the upward set window size is up to an initially set upper limit.

Accordingly, the transmitting RLC newly controls the window size by control information transmitted in the step S18, and finally increases up to an initial window size (S19). Like this, by adding or subtracting an amount of PDU data transmitted from the transmitting RLC, a communication can be controlled within a processing ability of the receiving buffer thus to prevent a data loss and a time delay.

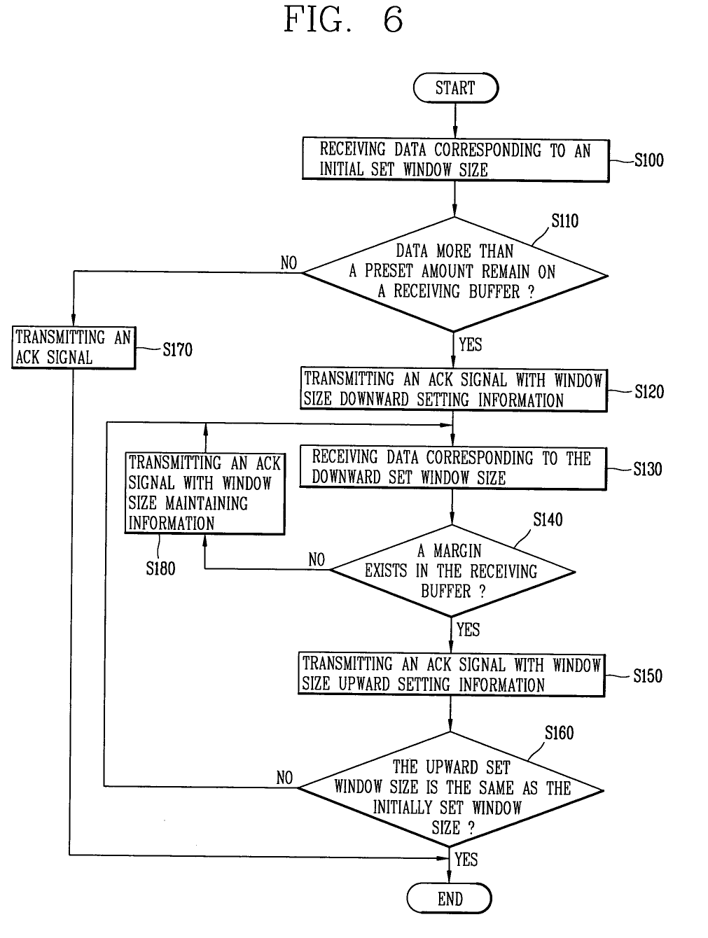

FIG. 6 is a flow chart of the preferred embodiment of the present invention, in which an inner SUFI of the status PDU transmitted in the RLC layer is used. Herein, an initial window size is set as a predetermined value and the value is supposed to be great.

Referring to FIG. 6, first, transmitted PDU data corresponding to the initial window size are received (S100). After completing up the reception, it is checked that PDUs more than a predetermined value remain in the buffer (Silo). At this time, if remaining PDUs do not exist, the ACK SUFI is contained in the status PDU and then transmitted to the transmitting RLC (S170).

In the meantime, in case that PDUs more than a predetermined value remain in the buffer after the reception completion, the receiving terminal processes it. At this time, a speed more than an air interface speed of the transmitting/receiving terminal is required. Also, if new data is received as the initial window size, a data loss can be generated. Therefore, the ACK SUFI and the window size SUFI having a downward set window size are contained in the status PDU and then transmitted to the transmitting RLC, thereby reducing a window size (S120). Herein, the downward set window size can be ‘1’.

The receiving RLC receives next PDUs in a state of the downward set window size (S130). First, it is checked that a margin is generated in the receiving buffer (S140).

At this time, if a margin does not exist in the buffer, the receiving RLC contains the ACK SUFI and window size maintaining information or window size reducing information in the status PDU and transmits to the transmitting RLC (S180).

In the meantime, if the receiving end has a margin to process already received buffer contents while processing corresponding PDU data due to a reception of data of a small size, the PDU data of a small size can request ACK information after a predetermined transmission. Herein, the ACK information can be required after one window data is transmitted according to a selection of the transmitting end.

After transmitting predetermined data, if the transmitting RLC requires ACK information, the receiving end simultaneously transmits an ACK SUFI and an upward set window size SUFI by referring to a current buffer margin, thereby increasing a window size of a next transmission (S150).

Then, it is checked that the upward set window size is the same as the initially set window size (S160). If the size is not same, the process returns to the step 130 for receiving data corresponding to the downward set window size and thus the steps (S130˜S160) are repeated.

As aforementioned, after reducing the window size, by repeating the steps (S130˜S160) for transmitting an ACK signal according to a buffer margin and properly controlling a window size, the window size is finally restored up to the initial window size. Also, during these successive processes, data to be received is not lost. Accordingly, in the RLC layer communication, by properly using the SUFI that a concrete using method has not been defined, an overflow of a buffer or a data loss can be prevented.

As aforementioned, according to the data transfer controlling method in a mobile communication system, the ACK signal for received PDU data is transmitted to the transmitting RLC and an order that a window size be controlled is simultaneously transmitted. Then, the transmitting RLC properly controls a window size and thereby transmits PDU data, so that predetermined data can be transmitted whenever a data transmission is completed and then the ACK signal can be required. Also, a size of next data becomes extremely small, the receiving buffer can receive the next data without a loss, and the previously received PDU data can be arranged by a sequence thus to be transmitted to the upper layer. In the upper layer, the previously received data are processed and the next data having a small size can be also processed without a problem, thereby reducing a waste of a radio resource.

Also, in the present invention, since an amount of transmitted PDU data is added or subtracted by a buffer margin, a communication can be controlled within a processing ability limit of the receiving end, thereby preventing a data loss and a time delay due to the data loss.

Besides, in the present invention, a positive using method of the window size SUFI only of which form has been defined was explained, thereby providing affirmative effects on the 3GPP communication standard.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A data transfer controlling method in a radio system which transmits and receives data in an acknowledgement mode, the method comprising the steps of:
transmitting window size control information from a receiver to a transmitter by a state of a receiving buffer; and
varying a transmitting window size by the transmitter according to the transmitted window size control information.

2. The method of claim 1, wherein the transmitter is a network and the receiver is a terminal.

3. The method of claim 1, wherein the window size control information is contained in status information thus to be transmitted.

4. The method of claim 1, wherein the window size control information is a window size super-field (SUFI).

5. The method of claim 3, wherein the status information further includes an ACK SUFI.

6. The method of claim 1, wherein the receiver adjusts a receiving window size to be the same as the transmitting window size.

7. The method of claim 1, wherein the window size control information includes window size downward setting information if a receiving buffer is in an overflow state.

8. The method of claim 7, wherein the downward set window size is 1.

9. The method of claim 1, wherein the window size control information includes window size upward setting information if a receiving buffer is not in an overflow state.

10. The method of claim 9, wherein the upward setting level is up to an upper limit.

11. A data transfer controlling method in a radio system which controls a flow of a radio link and includes an entity operated in an acknowledgement mode, wherein window size update information is transmitted from a receiving entity to a transmitting entity based on a processing speed of a receiving buffer.

12. The method of claim 11, wherein the entity is a radio link control (RLC).

13. The method of claim 11, wherein the receiving entity adjusts a receiving window size to be the same as a transmitting window size.

14. The method of claim 11, wherein the window size update information is transmitted through status information.

15. The method of claim 11, wherein the window size update information is a window size super-field (SUFI).

16. The method of claim 14, wherein the status information includes an ACK SUFI.

17. The method of claim 11, wherein the receiving entity determines a change of a window size according to a state of a receiving buffer.

18. The method of claim 17, wherein the receiving entity adjusts a window size to be downward set in case that data more than a certain level remain on the receiving buffer.

19. The method of claim 18, wherein the downward set window size is 1.

20. The method of claim 17, wherein the receiving entity adjusts a window size to be upward set in case that data more than a certain level do not remain on the receiving buffer.

21. The method of claim 20, wherein the upward setting level is up to an upper limit.

22. A data transfer controlling method in a radio data transfer of a mobile communication system, the method comprising the steps of:
receiving a protocol data unit (PDU) from a transmitting RLC;
checking a state of a stored receiving buffer by a receiving PDU;
transmitting window size control information according to a state of a receiving buffer to the transmitting RLC; and
varying a transmitting window size according to the window size control information by the transmitting RLC and thus transmitting PDUs.

23. The method of claim 22, wherein the receiving RLC adjusts a receiving window size to be the same as the transmitting window size.

24. The method of claim 22, wherein the window size control information includes window size downward setting information if the receiving buffer is in an overflow state.

25. The method of claim 24, wherein the downward set window size is 1.

26. The method of claim 22, wherein the window size control information is a window size SUFI.

27. The method of claim 22, wherein the window size control information is transmitted through status information.

28. The method of claim 27, wherein the status information is an ACK signal.

29. The method of claim 28, wherein the ACK signal includes an ACK SUFI.

30. The method of claim 22, wherein the window size control information includes window size upward setting information if the receiving buffer is not in an overflow state.

31. The method of claim 30, wherein the upward setting level is up to an upper limit.
